(19) United States
(12) Patent Application Publication
(10) Pub. No.: US 2012/0010939 A1
(43) Pub. Date: Jan. 12, 2012

(54) SOCIAL NETWORK BASED ONLINE ADVERTISING

(75) Inventors: Prabhakaran Krishnamoorthy, Bangalore (IN); Uday Sankar Sen, Bangalore (IN)

(73) Assignee: Yahoo! Inc., Sunnyvale, CA (US)

(21) Appl. No.: 12/831,967

(22) Filed: Jul. 7, 2010

(51) Int. Cl. G06Q 30/00

(52) U.S. Cl. 705/14.39; 705/14.49; 705/14.41

(57) ABSTRACT

Techniques are provided in which review, comment, or purchase information is obtained, associated with a first user and relating to a product or service, product or service type, or brand. A second user is identified who is in an explicit or implicit social network of the first user. An online advertisement is generated, targeted to a second user and relating to the first product or service, product or service type, or brand. The online advertisement is generated utilizing the review, comment, or purchase information, which may serve as a trusted implicit or explicit recommendation regarding a subject of the advertisement.

### BACKGROUND

People are naturally very often strongly influenced by the feedback, comments such as opinions, or purchases of others in their social network before, for example, making a purchase. For example, an individual knowing that a family member or friend has commented positively on a certain brand of a product, or recently bought a certain brand of a product, may well positively influence the chances that the individual will make a similar purchase.

There is a need for techniques in online advertising relating to, among other things, use, or optimal use, of review, comment or purchase information.

### SUMMARY

Some embodiments of the invention provide systems and methods in which review, comment (which can include opinion), or purchase information is obtained, the information being associated with a first user and relating to a product or service, product or service type, or brand. A second user is identified who is in an explicit or implicit social network of the first user. An online advertisement is generated, targeted to a second user and relating to the first product or service, product or service type, or brand. The online advertisement is generated utilizing the review, comment, or purchase information, which may serve as a trusted implicit or explicit recommendation regarding a subject of the advertisement.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

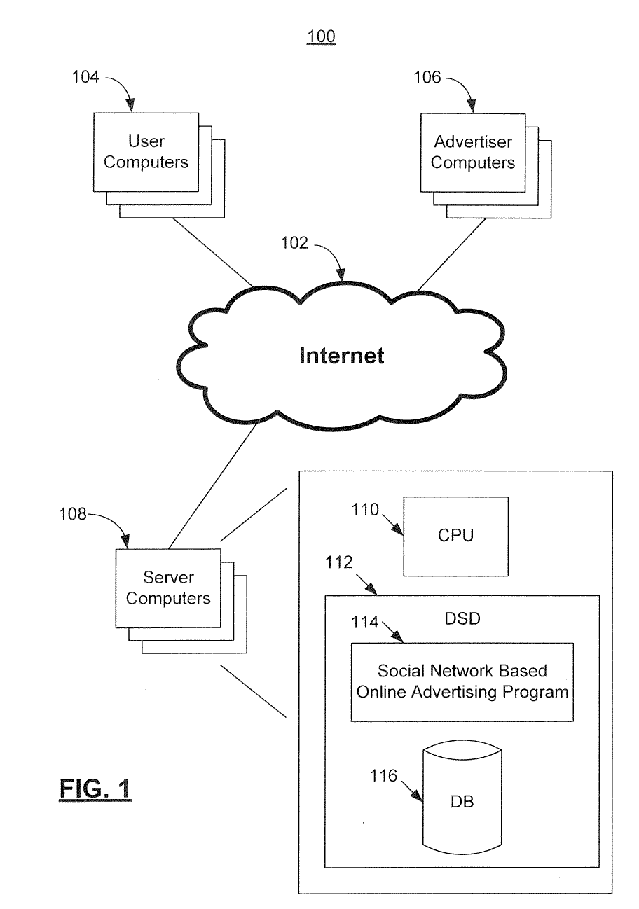

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Social Network Based Online Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

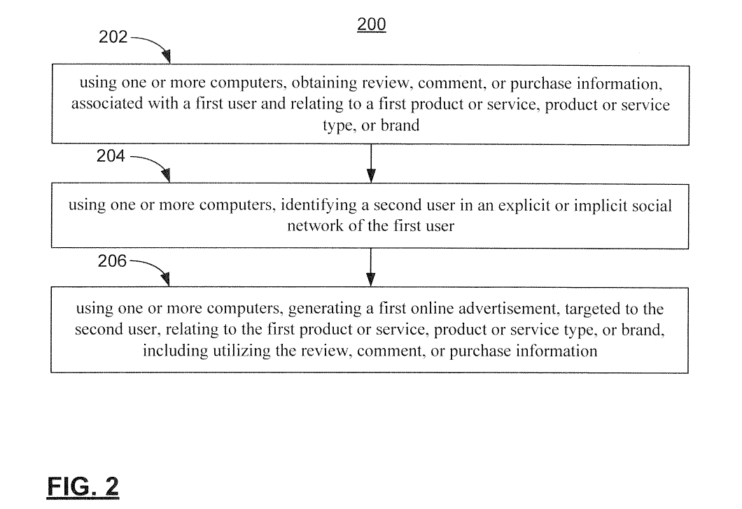

FIG. 2 is a flow diagram illustrating a method 200 according to one embodiment of the invention. At step 202, using one or more computers, review, comment, or purchase information is obtained, associated with a first user and relating to a first product or service, product or service type, or brand.

At step 204, using one or more computers, a second user is identified, in an explicit or implicit social network of the first user.

At step 206, using one or more computers, a first online advertisement is generated, targeted to the second user and relating to the first product or service, product or service type, or brand, including utilizing the review, comment, or purchase information.

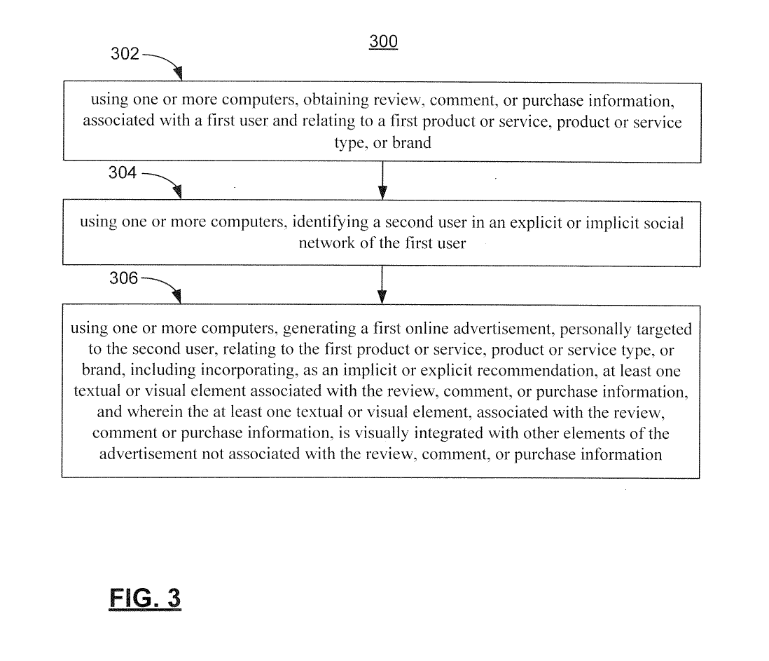

FIG. 3 is a flow diagram illustrating a method 300 according to one embodiment of the invention. At step 302, using one or more computers, review, comment, or purchase information is obtained, associated with a first user and relating to a first product or service, product or service type, or brand.

At step 304, using one or more computers, a second user is identified, in an explicit or implicit social network of the first user.

At step 306, using one or more computers, a first online advertisement is generated, personally targeted to the second user, relating to the first product or service, product or service type, or brand. Generating the first online advertisement includes incorporating, as an implicit or explicit recommendation, at least one textual or visual element associated with the review, comment, or purchase information. The at least one textual or visual element, associated with the review, comment or purchase information, is visually integrated with other elements of the advertisement not associated with the review, comment, or purchase information.

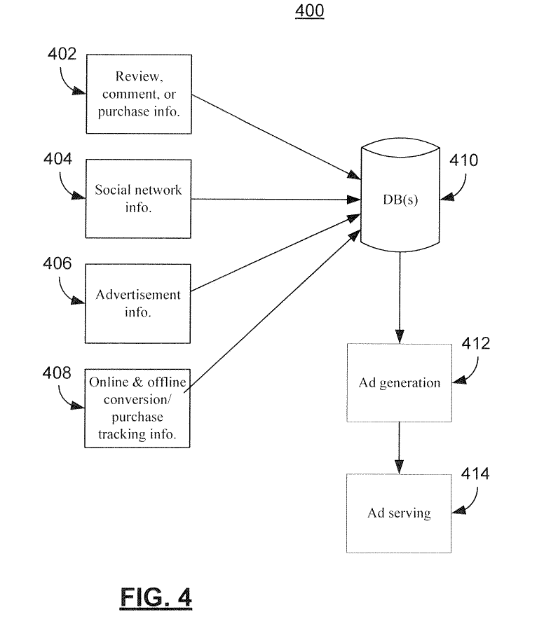

FIG. 4 is a block diagram 400 illustrating one embodiment of the invention. One or more data stores or databases 410 are depicted. Various types of information are stored in the database 410, which information may be obtained, gathered, or generated in various ways. In particular, types of depicted information stored in the database 410 include review (including opinion), comment, or purchase information 402, social network information 404, advertisement information 406, and online and offline conversion and purchase tracking information 408. As depicted at block 412, all these types of information, possibly among other types, is used in online advertisement generation 412, for serving 414 to a user.

Specifically, review, comment, or purchase information, relating to a particular user and a particular product or service, product or service type, or brand is obtained. Social network information is used to identify another user in a social network of the particular user. Review, comment, or purchase information may be combined or otherwise incorporated or integrated, perhaps after processing or re-formatting, with other advertisement information to generate an advertisement targeted to the other user, which may relate to the particular product or service, type of product or service, or brand, or something related or otherwise associated with the particular product or service, type of product or service, or brand. The generated advertisement is served to the other user. The incorporated or integrated review, comment, or purchase information may serve as a trusted implicit or explicit recommendation or enticement to the other user, by a person in a social network of the other user, to perform in some way solicited by the advertisement, such as by performing a particular online or offline conversion or purchase, or even simply clicking or selecting through the advertisement.

Furthermore, click, conversion or purchase information, for example, relating to the other user in connection with the advertisement, may be tracked, and used for any of various purposes, such as purposes in connection with an advertising campaign or determining metrics related to an advertising campaign. For example, tracked information can be used in assessing, determining, estimating, optimizing, or forecasting various online or offline advertising or advertising campaign parameters such as advertisement performance, value, or pricing.

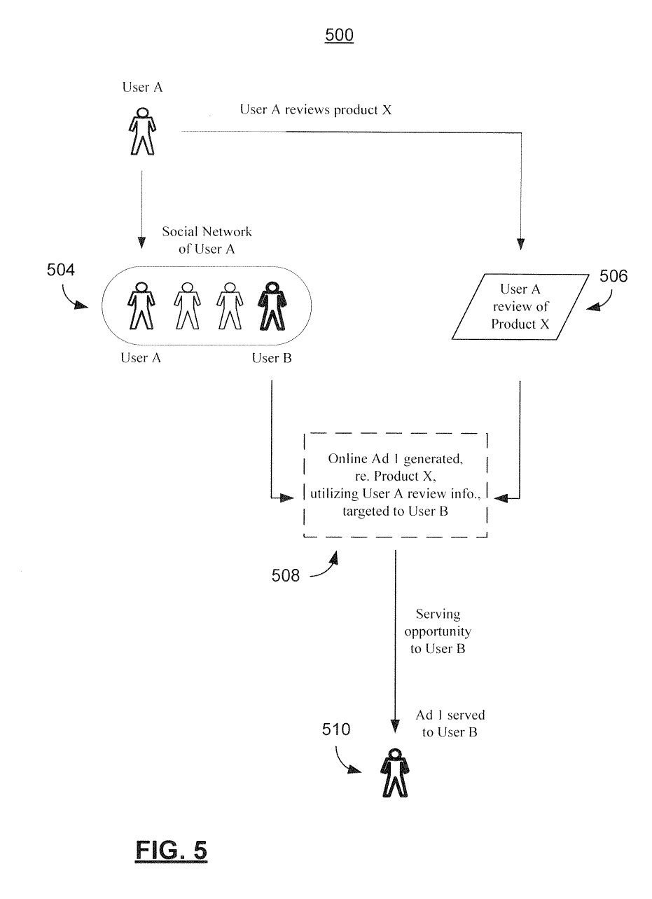

FIG. 5 is a block diagram 500 illustrating one embodiment of the invention. An online user, User A is depicted. User A posts or otherwise generates a review 506 of a certain product or brand, such as product X. User A is determined to be in one or more social networks with numerous other users, such as User B. Using social network information associating User A and User B, the review information posted by User A, and potentially various other types of information, such as product or advertisement information relating to product X or a related product or brand, potentially among other information, an online advertisement, Ad 1, is generated, as represented by block 508.

Ad 1 may be personally targeted to User B, and may incorporate or integrate elements of the review, as well as identify or reference User A, possibly including an indication of the relationship, association, or social network association between User A with user B, for instance. Furthermore, Ad 1 may include various personal, personal identity or biographical related information or elements relating to User A, such as user A's name, address, a picture, audio clip or video clip from or including User A, etc. Ad 1 may include one or more elements, such as textual, visual, graphical, video, or audio elements, that are integrated to include review information as well as other information, such as advertisement information relating to product X. When an appropriate serving opportunity arises, Ad 1 is served to User B.

Furthermore, in some embodiments, multiple reviews (or comments, purchase information, etc.) on a product or service, type of product or service, or brand can be collected from different users, each of whom may be associated with or in a social network of the targeted user. In some embodiments, for example, reviews from multiple users in a social network of a particular user may be aggregated. Elements from each of the reviews, and possibly also personal identity-related information or elements relating to each of the multiple reviewing users, can be incorporated in an advertisement targeted to the particular user.

Some embodiments of the invention provide methods and systems for use in online advertising, including targeted online advertising. Some embodiments include generating, or facilitating generation of, targeted advertisements using product reviews, opinions or comments, or using previous online or offline purchase information. Positive review information or purchase information may be used in facilitating targeted advertising. The information may be used in generating advertisements or advertisement content targeted to other users known to or in a social network of the reviewer or purchaser. Review or purchase information, as well as reviewer or purchaser identifying or referencing information, can be included in an advertisement targeted to an online user in the reviewer's or purchaser's social network, or otherwise known or associated with the reviewer or purchaser.

The advertisement can also include, for example, advertising information relating to a product that is the same or similar to the product reviewed or purchased by the reviewer or purchaser. The targeted user may be enticed to buy the product, or service, in part by the personalized and positive direct or indirect endorsement or recommendation effect of including the review or purchase information relating to the person in the targeted user's social network. Furthermore, the review or purchase information can be tied in, through content, visually, or both, with the product information and advertisement information. An integrated advertisement can be provided to catch the targeted user's attention with positive endorsement information from a person who may be known to the targeted user, naturally channeling the targeted user's attention to the advertisement information. This can lead to greater user interest or positivity, and can increase probability of click through, purchase or other conversion, for example.

In some embodiments, Web sites are crawled, analyzed, or otherwise reviewed to obtain online review and comment information on a product or type of product, such as by crawling Web sites for relevant content. Online purchase information may be obtained, for example, from seller databases or other databases including online purchase history information. Offline purchase or review information may be obtained by various means, including phone or mail surveys, or information provided from offline stores, such as purchase history information. Obtained online or offline review or purchase information can be used in generation of a targeted advertisement to a user in a social network of the reviewing or purchasing user or person.

In some embodiments, purchase information may be obtained through arrangements with entities that have such information, such as arrangements with banks, shopping malls, online retailers, online purchase and payment facilitators, etc.

In some embodiments, arrangements can be made with users, in which pre-formulated potential reviews are provided to the user. The user may be able to select or edit the potential reviews, choosing or generating an actual review. The actual review can be used in advertisements targeted to users in the reviewer's social network. The reviewer could be compensated for participation in any of various ways, including being provided with content, online or offline discounts, etc.

In some embodiments, advertisements can be generated from review or purchase information and reviewer and purchaser identity or social network relationship information, or can be supplemented or augmented with such information. The advertisement can be textual, visual, video, etc.

In some embodiments, reviewers and purchasers benefit at least from helping friends or others in their social networks, if not in other ways. Sellers, advertisers, publishers, advertising marketplace entities, and other entities benefit, for example, from increased probability of click or conversion and increased revenue.

In some embodiments, a premium can be charged, or otherwise worked into pricing or bidding, etc, to advertisers for the service of providing or facilitating such advertisements, since with advertisements may present a higher probability of conversion than more general advertisements. In some embodiments, pricing or bidding in a marketplace, such as an auction-based online advertising marketplace, can be based on, or partially based on, increased value of advertisements according to embodiments of the invention. In some embodiments, tracked conversion information can be used in determining such value or enhanced value.

Some embodiments of the invention contemplate arrangements in which users agree to, or even request, certain types of advertisement, advertisements in certain areas, or advertisements filtered in other ways. For example, in some embodiments, users may request or indicate a preference for advertisements associated with people in a social network of the user. Some embodiments contemplate providing advertisements in connection with such situations or arrangements, using information stored in one or more databases, including, for example, social network and advertisement information. Furthermore, information stored in data stores or databases according to embodiments of the invention can be mined or used in other ways or for other purposes.

Some embodiments of the invention contemplate sophisticated and integrated usage of both online and offline information, include usage in connection with integrated online and offline advertisement campaigns. For example, in some embodiments, both online and offline conversions or purchases, or other behavior, may be tracked and associated with particular advertisements, impressions, etc. Still further, in some embodiments, controlled experiments are used in this and other regards. For example, in some embodiments, behavior is tracked of a control group who have not received an advertisement, even though they meet any associated targeting criteria and otherwise would have received the advertisement, and of an experimental group who actually were shown the advertisement. Tracking of behavior of both groups, potentially both online and offline, and comparing them, can lead to inferences and metrics regarding the effectiveness or performance of the advertisement, such as conversion rate, etc. This, in turn, can be used in advertising campaign operations and optimization, for example.

Some embodiments include detecting buyers and collecting review information from social networking platforms. In some embodiments, reviews are structured to create or add to advertisements. Text or display advertisements, for example, can then be served to relatives or friends of the buyer and reviewer of a product, service or brand.

In some embodiments, purchase information itself can be converted into or used in an advertisement which is shown to people in the purchaser's network or networks, which can include obtaining permission from the buyer. In some such embodiments, no review information is needed.

In some embodiments, permission is obtained from a reviewer or purchaser before including review or purchase information, and possibly also personal identity information relating to the reviewer or purchaser, in advertisements. In some embodiments, it is not necessary to obtain permission many times. Instead, for example, general permission may be obtained only once to cover multiple occasions of usage. For example, one-time type permission could be obtained from a user to cover multiple instances, such as multiple instances of a certain kind of purchases over a specified period. After such permission is obtained, each time the user makes a purchase or generates a review, covered by the one-time permission, advertisements can be generated using the review or purchase information without obtaining permission from the user each time, increasing efficiency and saving system resources.

Some embodiments of the invention include offline advertising (such as newspaper or other print advertising, etc.) in addition to or instead of online advertising. For example, in some embodiments, advertisements generated using reviews or purchase information can be included in offline advertisements in newspapers, magazines, or in posting mailings to people, such as in association with coupons or promotions, etc.

Some embodiments include a recognition that, frequently, one takes suggestions from relatives or friends in deciding to, for example, buy a product of some brand, which can range from purchasing car, to going to a movie screening, etc. Positive feedback on a particular product may well tilt a buyer in favor of the particular brand, for example. As such, an advertiser can benefit by targeting an advertisement to some prospective buyer who is related to a satisfied customer, for example, which may be much more effective than a more general advertisement.

Furthermore, some embodiments include using purchase information in an advertisement. In many cases, purchase information itself can certainly influence relatives or friends to buy a product, for example.

Some embodiments include detecting buyers. In some embodiments, this can be done by arrangements, for example, with banks relating to credit card statements, with shopping malls, by tracking online purchases, for example, through Yahoo! Shopping or a product manufacturers registration or feed, etc., all potentially with any necessary or appropriate permissions or authorizations. In some embodiments, conversions or purchases following exposure to an advertisement can also be tracked using similar arrangements.

Some embodiments include collecting reviews, both online and offline. For example, in some embodiments, buyers may be contact to get the review information, whether online, through email, “snailmail”, phone etc. Furthermore, some embodiments include various automated ways to collect review information, such as by crawling review sites, blogs, social networking sites, etc. to get the review and reviewer information.

Various techniques are contemplated in relation to generating advertisements. For example, in some embodiments, a whole review may be used as or re-formatted as an advertisement. In some embodiments, positive or interesting points only from a review are selected and used in or converted to an advertisement.

In some embodiments, a reviewer or buyer may have indicated, or may provide, a score relating to product satisfaction, recommendation, etc. In some embodiments, such a score may be used in or converted into an advertisement, or may be incorporated and integrated into an overall advertisement, for example.

Various techniques are contemplated in identifying people in social networks, etc. For example, in some embodiments, persons related or associated with a reviewer are determined from a social networking site, email address books or other information, chats, etc.

Various techniques are contemplated regarding associating or tracking conversions, purchases, or other behavior, in connection with presented advertisements. As just one simple example, if a user displayed an advertisement for a product purchases that product within a certain time frame from display of the advertisement, or from clicking on the advertisement, etc., that purchase may be attributed to the advertisement. Many other techniques are contemplated.

Some embodiments provide highly personalized advertisements. Furthermore, a known person's implicit or explicit recommendation can serve as an effective advertisement or endorsement. The potential buyer may get the benefit of, for example, a first-hand, trusted recommendation, which buyers often look for. Furthermore, in some embodiments, since the advertiser benefits in this scenario, the advertiser may pass some benefit onto the reviewing user, helping to motivate and reward the reviewing user for any participation or permissions. Furthermore, in some embodiments, various incentives can be provided to users in connection with providing reviews to be used in generating advertisements, whether the incentives are offered by an advertiser or otherwise. For example, in some embodiments, users, without making a purchase, can be provided with benefit such as free samples of a product or service, in return for which (or just based at least in part on the incentive or good will generated from being provided with the free samples), the users provide reviews or comments that can be used in advertisements.

Some embodiments also recognize that service providers or online portals benefit, obtaining more revenue by effectively monetizing in the social networking space. Furthermore, in some embodiments, advertisements including reviews, for example, can be priced at a premium to advertisers, given their higher anticipated or proven performance. Still further, various information collected and stored in databases according to embodiments can be mined and used in various other ways, such as for various means of monetization, user targeting, statistical information collection and analysis, etc.

While the invention is described with reference to the above drawings, the drawings are intended to be illustrative, and the invention contemplates other embodiments within the spirit of the invention.

1. A method comprising:
using one or more computers, obtaining review, comment, or purchase information, associated with a first user and relating to a first product or service, product or service type, or brand;
using one or more computers, identifying a second user in an explicit or implicit social network of the first user; and
using one or more computers, generating a first online advertisement, targeted to the second user, relating to the first product or service, product or service type, or brand, comprising utilizing the review, comment, or purchase information.

2. The method of claim 1, comprising facilitating serving of the first online advertisement to the second user.

3. The method of claim 1, comprising serving of the first online advertisement to the second user.

4. The method of claim 1, wherein generating the first advertisement comprises incorporating at least one element identifying the first user or relating to the personal identity of the first user.

5. The method of claim 1, comprising obtaining and aggregating review, comment or purchase information from multiple users, and comprising including elements of the review, comment or purchase information from each of the multiple users in an advertisement targeted to a particular user, wherein each of the multiple users are in a social network of the particular user.

6. The method of claim 1, wherein generating the first advertisement comprises incorporating one or more elements of the review, comment or purchase information.

7. The method of claim 1, wherein generating the first advertisement comprises incorporating positive portions or aspects of the review, comment or purchase information.

8. The method of claim 1, wherein generating the first advertisement comprises incorporating purchase information of the review, comment or purchase information.

9. The method of claim 1, wherein identifying a second user comprises identifying a family member or online friend of the first user.

10. The method of claim 1, wherein identifying a second user comprises identifying a second user in an online social network of the first user.

11. The method of claim 1, wherein generating a first online advertisement comprises including elements that are personally targeted to the second user.

12. The method of claim 1, wherein generating a first online advertisement comprises integrating elements of the review, comment or purchase information into the first online advertisement.

13. The method of claim 1, comprising tracking a conversion determined to be associated with the first online advertisement.

14. The method of claim 1, comprising tracking a conversion, whether online or offline, determined to be associated with the first online advertisement.

15. The method of claim 1, comprising presenting pre-generated or suggested review or comment information to the first user for approval, and comprising utilizing, after approval, the review or comment information in generating the first online advertisement.

16. The method of claim 1, comprising presenting pre-generated, suggested review or comment information to the first user for approval, and comprising utilizing, after approval, the review or comment information in generating the first online advertisement, and comprising allowing the first user to edit the review or comment information before approval.

17. The method of claim 1, comprising compensating or rewarding the first user for providing or allowing use of the review, comment, or purchase information.

18. The method of claim 1, comprising, in an auction-based online advertising marketplace, pricing the first online advertisement at a premium.

19. A system comprising:
one or more server computers coupled to a network; and
one or more databases coupled to the one or more server computers;
wherein the one or more server computers are for:
obtaining review, comment, or purchase information, associated with a first user and relating to a first product or service, product or service type, or brand;
identifying a second user in an explicit or implicit social network of the first user; and
generating a first online advertisement, targeted to the second user, relating to the first product or service, product or service type, or brand, comprising utilizing the review, comment, or purchase information.

20. The system of claim 19, comprising storing the review, comment, or purchase information in at least one of the one or more databases.

21. The system of claim 19, comprising storing the first online advertisement in at least one of the one or more databases.

22. A computer readable medium or media containing instructions for executing a method comprising:
using one or more computers, obtaining review, comment, or purchase information, by a first user and relating to a first product or service, product or service type, or brand;
using one or more computers, identifying a second user in an explicit or implicit social network of the first user;
using one or more computers, generating a first online advertisement, personally targeted to the second user, relating to the first product or service, product or service type, or brand, comprising incorporating, as an implicit or explicit recommendation, at least one textual or visual element associated with the review, comment, or purchase information, and wherein the at least one textual or visual element, associated with the review, comment or purchase information, is visually integrated other elements of the advertisement not associated with the review, comment, or purchase information.
